(19) United States
(12) Patent Application Publication
(10) Pub. No.: US 2025/0188788 A1
(43) Pub. Date: Jun. 12, 2025

(54) FURNITURE DRIVE

(71) Applicant: Julius Blum GmbH, Heochst (AT)

(72) Inventors: Klaus MATTLE, Koblach (AT); Alexander Peterlunger, Lustenau (AT)

(21) Appl. No.: 19/058,310

(22) Filed: Feb. 20, 2025

Related U.S. Application Data
(63) Continuation of application No. PCT/AT2023/060302, filed on Aug. 30, 2023.

(30) Foreign Application Priority Data
Sep. 9, 2022 (AT) A 50690/2022

(51) Int. Cl. E05F 15/63

(52) U.S. Cl. CPC E05F 15/63; E05Y 2900/20

(57) ABSTRACT

A furniture drive includes an electric motor, an actuator movable between two end positions for applying a force to the furniture part to be driven, and a gearing interposed between the electric motor and the actuator. The one electric motor and the actuator are arranged above each other substantially in a common plane, and the electric motor and the gearing are arranged in a first housing and the actuator is arranged in a second housing. The second housing is constructively separated from the first housing, and a lever arrangement pivotally connects the actuator to the housing. The actuator, in at least one of the two end positions, and the electric motor are substantially entirely integrated into a common furniture panel of the furniture carcass.

The present application is a continuation of International Application PCT/AT2023/060302 filed on Aug. 30, 2023. Thus, all of the subject matter of International Application PCT/AT2023/060302 is incorporated herein by reference.

### BACKGROUND OF THE INVENTION

The present invention relates to a furniture drive for driving a movable furniture part. The furniture drive comprises: at least one electric motor, at least one actuator movable between two end positions for applying a force to the furniture part to be driven, and a gearing interposed between the electric motor and the actuator. The at least one electric motor and the at least one actuator are arranged above each other substantially in a common plane, and the electric motor and the gearing are arranged in a first housing and the actuator is arranged in a second housing. The second housing is constructively separated from the first housing, and a lever arrangement pivotally connects the actuator to the housing.

Moreover, the invention concerns an item of furniture, preferably an upper cabinet, comprising a furniture carcass formed of furniture panels, a furniture part movable relative to the furniture carcass, and a furniture drive for driving the movable furniture part.

Furniture drive systems comprising an actuator and an additional electric motor for driving a movable furniture part are already known, for example as disclosed in WO 2008/134786 A1, WO 2010/129979 A1 and WO 2017/177247 A1. The actuator includes an actuating arm pressurized by a force storage member for moving the movable furniture part. In order to further assist a movement of the actuating arm, optionally an electric drive unit can be releasably connected to the actuator. The actuator and the electric drive unit are configured as constructional units separate from each other, and the electric drive unit, if required, can be provided as an additional and easily replaceable drive module. A drawback is the fact that the installation space of the furniture drive is relatively large in a connected condition between the actuator and the electric drive unit and cannot be used for specific applications.

Further furniture drives are disclosed in DE 102019102057 A1, WO 2020058363 A1, DE 202007006687 U1 and in U.S. Pat. No. 2,912,237 A.

### SUMMARY OF THE INVENTION

It is an object of the present invention to propose a furniture drive of the type mentioned in the introductory part, thereby avoiding the above-discussed drawbacks.

According to the invention, the actuator, in at least one of the two end positions, and the electric motor are configured to be substantially entirely integrated into a common furniture panel of the furniture carcass.

In this way, the width of the furniture drive can be reduced such that the furniture drive can be arranged also in a concealed manner within a furniture panel (for example having a maximum thickness of 19 mm or 16 mm) of an item of furniture. Thus, a very compact arrangement of the furniture drive can be made possible, and the available space within the interior of the furniture carcass is not restricted.

Because the furniture drive does hardly come into appearance in a mounted condition, an overall visual impression can be improved. For example, a visual attractive, uniform and an intact surface finish of the furniture panel can be provided on its inside and on its outside.

According to a preferred embodiment, the common housing is configured to be arranged within a wall thickness of a furniture panel, preferably having a thickness of less than 20 mm.

Preferably, the two housings are arranged substantially in a common plane above each other in a coupled condition.

### BRIEF DESCRIPTION OF THE DRAWINGS

Further details and advantages of the present invention will be apparent from the following description with reference to the drawings, in which:

FIG. 1a, 1b show an item of furniture in a perspective view and in an exploded view,

FIG. 2 shows an embodiment of a furniture drive in a perspective view,

FIG. 3a, 3b show an embodiment of a furniture drive with a transmission device to be retrofitted, the transmission device comprising a lever for coupling between the gearing and the actuator, and an enlarged detail view thereof, and

FIG. 4a, 4b show a further embodiment of a furniture drive with a transmission device comprising tooth arrangements for coupling between the gearing and the actuator, and an enlarged detail view thereof.

### DETAILED DESCRIPTION OF THE INVENTION

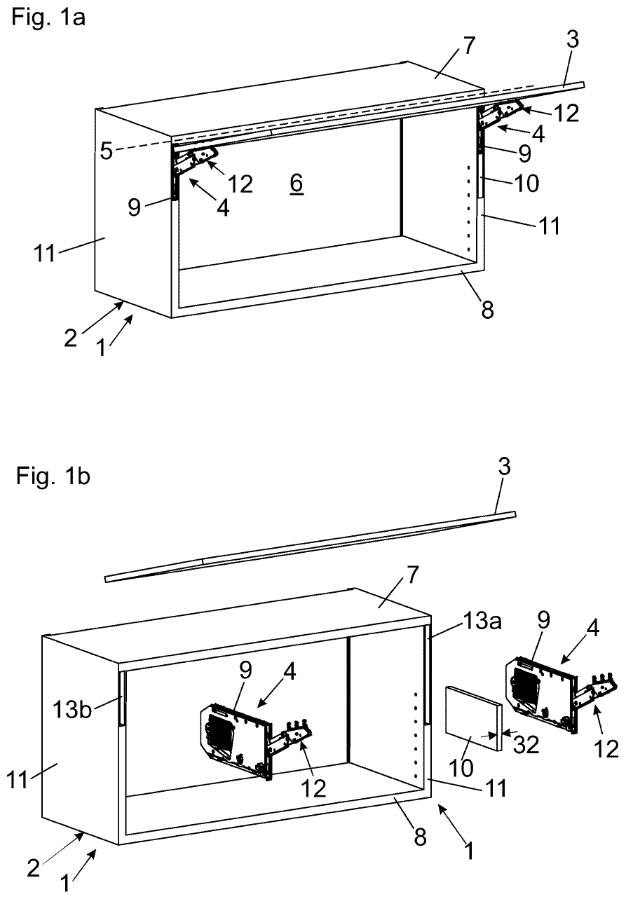

FIG. 1a shows an item of furniture 1 in the form of an upper cabinet, comprising a furniture carcass 2 and a furniture part 3 movable relative to the furniture carcass 2. The furniture part 3 is configured as a flap to be opened in an upward direction. The movable furniture part 3 is movably supported about a horizontally extending axis 5 relative to the furniture carcass 2 via furniture drives 4.

The item of furniture 1 can include, as shown in the depicted case, a rear wall 6, a top panel 7 and a bottom panel 8.

The item of furniture 1 can include furniture panels 11 in the form of sidewalls, and at least one housing 9, 10 of the furniture drives 4 is substantially entirely inserted into a recess 13a, 13b (FIG. 1b) of the furniture panels 11.

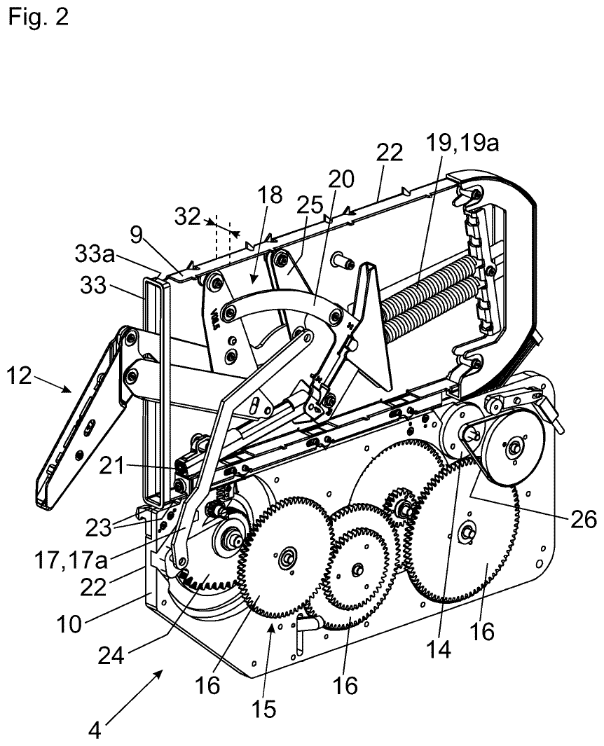

FIG. 1b shows the item of furniture 1 according to FIG. 1a in an exploded view. An electric motor 14 (FIG. 2) is arranged within the housing 10 which is only schematically depicted in FIG. 1b. The actuator 12 is pivotally arranged on the housing 9, the actuator 12 being connected or being configured to be connected to the movable furniture part 3.

Preferably, both housings 9, 10 have a maximum width 32 of less than 18 mm, preferably of less than 16 mm.

It is not necessary for all furniture drives 4 to be equipped with an electromotive drive unit. In the depicted case, only one of the two furniture drives 4 includes an electromotive drive unit.

Alternative embodiments of an item of furniture 1 are conceivable, in which the furniture drives 4 according to the invention can be employed.

The item of furniture 1 is preferably configured as an upper cabinet and includes the following features:
at least one furniture carcass 2 formed of furniture panels 11,
at least one movable furniture part 3 in the form of a flap to be opened in an upward direction, and
at least one furniture drive 4, the furniture part 3 being movably supported on the item of furniture 1 via the at least one furniture drive 4, the furniture drive 4 including at least one electric motor 14 (FIG. 2), at least one actuator 12 configured to be moved between two end positions for applying a force to the furniture part 3 to be driven, and a gearing 15 (FIG. 2) interposed between the electric motor 14 and the actuator 12,
   wherein the actuator 12, in at least one of the two end positions, and the electric motor 14 are substantially entirely integrated into a common furniture panel 11 of the furniture carcass 2.

According to a preferred embodiment, the housing 9, 10 of the at least one furniture drive 4 is substantially entirely inserted into a recess 13a, 13b of the furniture panel 11.

FIG. 2 shows a furniture drive 4 for driving a movable furniture part 3, in which the furniture drive 4 includes at least one housing 9, 10, at least one electric motor 14, at least one actuator 12, preferably movable between two end positions, for applying a force to the furniture part 3 to be driven, and a gearing 15 switched between the electric motor 14 and the actuator 12.

The electric motor 14 and the gearing 15 are arranged in a first housing 10, and the actuator 12 is arranged in a second housing 9 constructively separated from the first housing 10. In a coupled condition, the two housings 9, 10 are arranged above each other substantially in a common plane.

For example, the electric motor 14 can be configured as an external rotor motor or as a disc motor. These motors are characterized by a relatively flat design, so that the electric motor 14 can be integrated within a wall thickness of a furniture panel 11. By virtue of an external rotor motor or a disc motor, a large driving force in proportion to the diameter of the motor can be provided.

For transmitting a force from the electric motor 14 to the gearing 15, at least one drive belt 26 can be provided. The usage of a drive belt 26 has the advantage that the drive belt 26 serves as a first gear stage so as to reduce the high rotation speed of the electric motor 14. Moreover, noise emissions of the furniture drive 4 can also be reduced by the drive belt 26.

At least one transmission device 17 is provided by which the gearing 15 is connected or, alternatively, is releasably connectable to the actuator 12. The transmission device 17 can include at least one lever 17a and/or at least one tooth arrangement 31a, 31b (FIG. 4a, 4b). However, alternative embodiments of the transmission device 17 are also conceivable.

According to possible embodiments, the at least one lever 17a of the transmission device 17:
is connected or is configured to be releasably connected to at least one transmission element 24 of the gearing 15, and/or
is connected or is configured to be releasably connected to at least one pivotable lever 25 of the actuator 12, and/or
is at least partially arranged within and/or at least partially arranged outside a housing 9, 10 of the furniture drive 4, and/or
is configured to be curved at least over a region, and/or
is configured to be, preferably releasably, connected to the actuator 12 and/or to the gearing 15 also when the actuator 12 and/or to the electric drive 14 is or are already pre-mounted to the furniture carcass 2.

At least one lever arrangement 18 is provided by which the actuator 12 is pivotally connected to the housing 9. In the present case, the lever arrangement 18 forms a 7-joint-arrangement.

At least one mechanical force storage member 19 is provided by which a force can be applied to the actuator 12 in order to compensate for a weight force of the furniture part 3 to be driven. For example, the mechanical force storage member 19 can include one or a plurality of compression springs 19a and/or at least one tension spring and/or at least one gas pressure spring.

For transmitting a force stored in the mechanical force storage member 19 to the actuator 12, at least one force-transmitting lever 20 can be provided. Further, a force adjustment device 21 can be provided for adjusting a pre-stressing force of the force storage member 19. Preferably, the force adjustment device 21 is configured to be actuated from a front face of the housing 9.

The actuator 12, in a first end position corresponding to a closed position of the movable furniture part 3, is arranged substantially entirely within the housing 9. The gearing 15 includes a plurality of gear stages 16 in which also an overload coupling and/or a freewheel coupling can be integrated.

According to possible embodiments, the first housing 10 and/or the second housing 9:
is configured substantially cuboidal, and/or
includes two housing walls 22 partially spaced apart from each other, and/or
each includes a housing wall 22 which, in a coupled condition, is arranged above each other in a common plane with a housing wall 22 of the other housing 9, 10, and/or
includes longitudinal side 23 which, in a coupled condition, at least partially bears against a longitudinal side 23 of the other housing 9, 10, and/or
has a maximum width 32 which is substantially identical to a maximum width 32 of the other housing 9, 10, and/or
has a maximum width 32 of less than 18 mm, preferably of less than 16 mm, and/or
has a maximum height which is substantially identical to a maximum height of the other housing 9, 10.

For reasons of improved overview, a covering second housing wall 22 of the housings 9, 10 is not depicted in FIG. 2.

In the shown embodiment, it can be seen that the electric motor 14, in the position of use of the furniture drive 4, is arranged below the actuator 12.

According to a preferred embodiment, the housing 9, 10 of the at least one furniture drive 4 is substantially entirely inserted into a recess 13a, 13b (FIG. 1b) of the furniture panel 11. Further, at least one cover 33 can be provided, the at least one cover 33 having at least one laterally projecting and, preferably substantially ring-shaped, flange 33a. By virtue of the laterally projecting flange 33a, the peripheral region of the recess 13a, 13b (FIG. 1b) of the furniture panel 11 can be covered. In this way, an elaborate finishing of the peripheral region can be omitted, even when the peripheral region is somewhat frayed. Preferably, the actuator 12 can be guided through the at least one cover 33 in at least one relative position.

The at least one cover 33 can be connected to the first housing 10 and/or to the second housing 9. Alternatively, it is possible that the at least one cover 33 is configured as a component separate from the housings 9, 10, and the separate component is configured to be connected, preferably locked, to at least one of the two housings 9, 10. Preferably, the at least one cover 33 surrounds, preferably substantially entirely, the first housing 10 and/or the second housing 9. In this way, a peripheral region of the recess 13a, 13b (FIG. 1b) of the furniture panel 11 can be covered, the peripheral region surrounding the first housing 10 and/or the second housing 9.

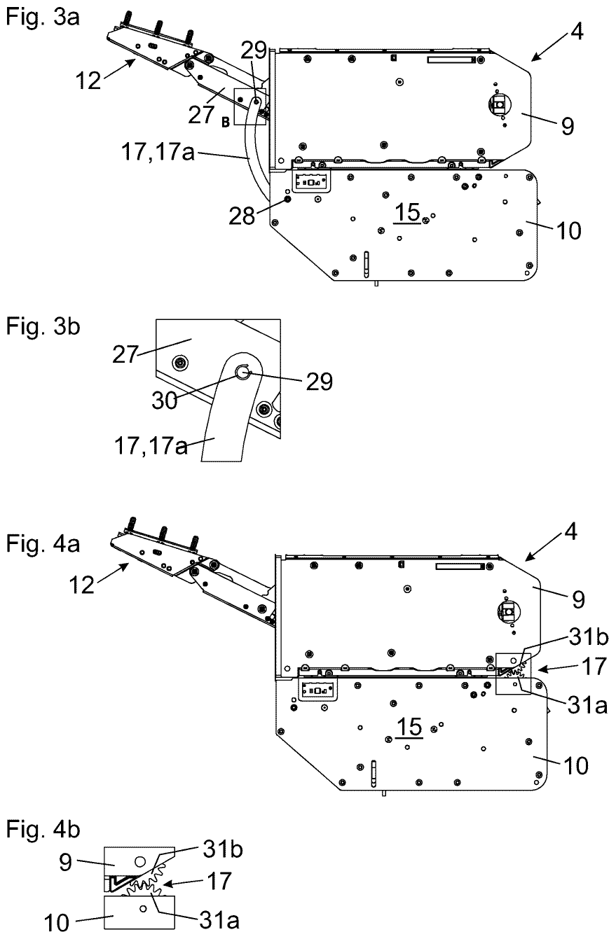

FIG. 3a shows an embodiment of a furniture drive 4 with a transmission device 17 for coupling between the gearing 15 and the actuator 12, the transmission device 17 being configured to be retro-fitted. As a result, the transmission device 17 is also connectable to the furniture drive 4 when the furniture drive 4 has already been pre-mounted to the furniture carcass 2.

In the shown embodiment, the transmission device 17 includes at least one lever 17a configured to be connected, preferably releasably, to the gearing 15 and/or to the actuator 12.

For mounting the lever 17a:
the lever 17a is to be inserted into the first housing 10,
is configured to be hung onto a movably-supported transmission element 28 of the gearing 15,
is pivotable in a hung-on condition, and
is configured to be fixed to a fastening location 29, preferably to a pivotable actuating arm 27, of the actuator 12.

FIG. 3b shows the framed region of FIG. 3a in an enlarged view. For example, the fastening location 29 of the actuator 12 can be in the form of a bolt projecting transversely from the actuating arm 27. The lever 17a of the transmission device 17 is fixable to the actuator 12 by a holding element 30, for example by a spring clip.

In a mounted condition, the lever 17a is partially arranged within a housing 9, 10 of the furniture drive 4 and/or partially arranged outside a housing 9, 10 of the furniture drive 4.

FIG. 4a shows a further embodiment of a furniture drive 4 with a transmission device 17 comprising tooth arrangements 31a, 31a for coupling between the gearing 15 and the actuator 12. According to possible embodiments, the at least one tooth arrangement 31a of the transmission device 17:
is connected to the gearing 15 in a movement-coupled manner, and/or
partially projects out from a housing 10 in which the electric motor 14 and the gearing 15 are arranged, and/or
co-operates with at least one further tooth arrangement 31b which is connected to the actuator 12 in a movement-coupled manner, preferably wherein the at least one further tooth arrangement 31b partially projects out from a housing 9 on which the actuator 12 is movably arranged, and/or
is configured as a rotatably-supported gear.

FIG. 4b shows the framed region of FIG. 4a in an enlarged view.

1. A furniture drive for driving a movable furniture part in the form of a flap to be opened in an upward direction, the furniture drive comprising:
at least one electric motor,
at least one actuator movable between two end positions for applying a force to the furniture part to be driven,
a gearing interposed between the electric motor and the actuator,
wherein the at least one electric motor and the at least one actuator are arranged above each other substantially in a common plane,
wherein the electric motor and the gearing are arranged in a first housing and the actuator is arranged in a second housing, the second housing being constructively separated from the first housing,
wherein a lever arrangement is provided by which the actuator is pivotally connected to the housing,
wherein the actuator, in at least one of the two end positions, and the electric motor are configured to be substantially entirely integrated into a common furniture panel of the furniture carcass.

2. The furniture drive according to claim 1, wherein the two housings are arranged substantially in a common plane above each other in a coupled condition.

3. The furniture drive according to claim 1, wherein the first housing and/or the second housing
is configured substantially cuboidal, and/or
includes two housing walls partially spaced apart from each other, and/or
each includes a housing wall which, in a coupled condition, is arranged above each other in a common plane with a housing wall of the other housing, and/or
includes longitudinal side which, in a coupled condition, at least partially bears against a longitudinal side of the other housing, and/or
has a maximum width which is substantially identical to a maximum width of the other housing, and/or
has a maximum width of less than 18 mm, preferably of less than 16 mm, and/or
has a maximum height which is substantially identical to a maximum height of the other housing.

4. The furniture drive according to claim 1, wherein the electric motor, in a position of use of the furniture drive, is arranged below the actuator.

5. The furniture drive according to claim 1, wherein at least one transmission device is provided, the gearing being connected or being configured to be connected to the actuator by the transmission device, preferably wherein the transmission device includes at least one lever and/or at least one tooth arrangement.

6. The furniture drive according to claim 5, wherein the at least one lever of the transmission device:
is connected or is configured to be releasably connected to at least one transmission element of the gearing, and/or
is connected or is configured to be releasably connected to at least one pivotable lever of the actuator, and/or
is at least partially arranged within and/or at least partially arranged outside a housing of the furniture drive, and/or
is configured to be curved at least over a region, and/or
is configured to be, preferably releasably, connected to the actuator and/or to the gearing also when the actuator and/or the electric motor is or are already pre-mounted to a furniture carcass.

7. The furniture drive according to claim 5, wherein the at least one tooth arrangement of the transmission device:
is connected to the gearing in a movement-coupled manner, and/or
partially projects out from a housing in which the electric motor and the gearing are arranged, and/or
co-operates with at least one further tooth arrangement which is connected to the actuator in a movement-coupled manner, preferably wherein the at least one further tooth arrangement partially projects out from a housing on which the actuator is movably arranged, and/or
is configured as a rotatably-supported gear.

8. The furniture drive according to claim 1, wherein the furniture drive includes at least one housing having a maximum width of less than 18 mm, preferably of less than 16 mm.

9. The furniture drive according to claim 1, wherein the electric motor is configured as an external rotor motor or as a disc motor.

10. The furniture drive according to claim 1, wherein at least one drive belt is provided for transmitting a force from the electric motor to the gearing.

11. The furniture drive according to claim 1, wherein:
at least one mechanical force storage member is provided, and a force for compensating for a weight force of the furniture part to be driven can be applied to the actuator by the force storage member, and/or
the actuator, in a first end position, is arranged substantially entirely within the housing.

12. The furniture drive according to claim 1, further comprising at least one cover, wherein the at least one actuator, in at least one relative position, can be guided through the at least one cover, preferably wherein the at least one cover:
includes at least one laterally projecting and, preferably ring-shaped, flange, and/or
at least partially covers a peripheral region of the furniture panel, the peripheral region surrounding the furniture drive in a mounted condition of the furniture drive, and/or
is connected to the furniture drive or is configured as a separate component adapted to be, preferably releasably, connected to the furniture drive.

13. An item of furniture, preferably upper cabinet, comprising:
at least one furniture carcass formed of furniture panels,
at least one movable furniture part in the form of a flap to be opened in an upward direction,
the furniture drive according to claim 1, wherein the furniture part is movably-supported on the item of furniture via the at least one furniture drive, the furniture drive including at least one electric motor, at least one actuator movable between two end positions for applying a force to the furniture part to be driven, and a gearing interposed between the electric motor and the actuator,
wherein the actuator, at least in one of the two end positions, and the electric motor are substantially entirely integrated into a common furniture panel of the furniture carcass.

14. The item of furniture according to claim 13, wherein the housing of the at least one furniture drive is substantially entirely inserted into a recess of the furniture panel, preferably wherein at least one cover at least partially covers a peripheral region of the recess.
